(19) United States
(12) Patent Application Publication
(10) Pub. No.: US 2008/0303800 A1
(43) Pub. Date: Dec. 11, 2008

(54) Touch-based input device providing a reconfigurable user interface

(76) Inventor: James K. Elwell, Salt Lake City, UT (US)

Correspondence Address: THORPE NORTH & WESTERN, LLP., P.O. Box 1219, SANDY, UT, 84091-1219, US

(21) Appl. No.: 12/154,674

(22) Filed: May 22, 2008

Related U.S. Application Data
(60) Provisional application No. 60/931,400, filed on May 22, 2007.

(51) Int. Cl. G06F 3/041; G06K 11/06

(52) U.S. Cl. 345/173; 178/18.01

(57) ABSTRACT

A touch-based input device is disclosed providing a reconfigurable user interface. Said touch-based input device comprises an input receiving element having a touch sensitive contacting surface as part of a first configured user interface adapted to receive an applied force, a sensing element operable to detect and to determine at least a location of said applied force, and at least one static component removably disposed at a first location about said input receiving element, and adapted to at least partially define said first configured user interface. Said static component is movable to a second location about said input receiving element to reconfigure said user interface and to at least partially define a second configured user interface.

### RELATED APPLICATIONS

This application claims the benefit of U.S. Provisional Application Ser. No. 60/931,400, filed May 22, 2007, and entitled, “User Interfaces Operable with a Force-Based Input Device,” which is incorporated by reference in its entirety herein.

### FIELD OF THE INVENTION

The present invention relates to input devices, touch panels, computer displays and the like, and more particularly to the various user interfaces, namely physical interfaces, utilities, attachments, components, etc. that may be operable with and/or supported about these.

### BACKGROUND OF THE INVENTION AND RELATED ART

Input devices (e.g., a touch screen or touch pad) are designed to detect the application of an object and to determine one or more specific characteristics of or relating to the object as relating to the input device, such as the location of the object as acting on the input device, the magnitude of force applied by the object to the input device, etc. Examples of some of the different applications in which input devices may be found include computer display devices, kiosks, games, point of sale terminals, vending machines, medical devices, keypads, keyboards, and others.

Currently, there are a variety of different types of input devices. Some examples include resistive-based input devices, capacitance-based input devices, surface acoustic wave-based devices, force-based input devices, infrared-based devices, and others. While providing some useful functional aspects, each of these prior related types of input devices suffer in one or more areas.

Resistive-based input devices typically comprise two conductive plates that are required to be pressed together until contact is made between them. Resistive sensors only allow transmission of about 75% of the light from the input pad, thereby preventing their application in detailed graphic applications. In addition, the front layer of such devices is typically comprised of a soft material, such as polyester, that can be easily damaged by hard or sharp objects, such as car keys, pens, etc. As such, this makes them inappropriate for most public-access applications.

Capacitance-based input devices operate by measuring the capacitance of the object applying the force to ground, or by measuring the alteration of the transcapacitance between different sensors. Although inexpensive to manufacture, capacitance-based sensors typically are only capable of detecting large objects as these provide a sufficient capacitance to ground ratio. In other words, capacitance-based sensors typically are only capable of registering or detecting application of an object having suitable conductive properties, thereby eliminating a wide variety of potential useful applications, such as the ability to detect styli and other similar touch or force application objects. In addition, capacitance-based sensors allow transmission of about 90% of input pad light.

Surface acoustic wave-based input devices operate by emitting sound along the surface of the input pad and measuring the interaction of the application of the object with the sound. In addition, surface acoustic wave-based input devices allow transmission of 100% of input pad light, and don't require the applied object to comprise conductive properties. However, surface acoustic wave-based input devices are incapable of registering or detecting the application of hard and small objects, such as pen tips, and they are usually the most expensive of all the types of input devices. In addition, their accuracy and functionality is affected by surface contamination, such as water droplets.

Infrared-based devices are operated by infrared radiation emitted about the surface of the input pad of the device. However, these are sensitive to debris, such as dirt, that affect their accuracy.

Each of these types of input devices also suffer from their inability to provide different utilities and interfaces other than simply a touch surface that might have various graphics or other indicia thereon. As such, these input devices tend to be very generic in both their function and appearance.

### SUMMARY OF THE INVENTION

In light of the problems and deficiencies inherent in the prior art, the present invention seeks to overcome these by providing a touch-sensitive input device capable of operably supporting one or more integrally formed, coupled or add-on interfaces or utilities, referred to herein as components or static components, about a touch-sensitive element, which static components provide the input device with more enhanced and stimulating possible user interfaces and functionality, such as added features, capabilities, aesthetics, etc.

In accordance with the invention as embodied and broadly described herein, the present invention resides in a touch-based input device providing a reconfigurable user interface, the touch-based input device comprising an input receiving element having a touch sensitive contacting surface as part of a first configured user interface adapted to receive an applied force; a sensing element operable to detect and to facilitate determination of at least a location and/or magnitude of the applied force; and at least one static component removably disposed at a first location about the input receiving element, and adapted to at least partially define the first configured user interface, the static component being movable to a second location about the input receiving element to reconfigure the user interface and to at least partially define a second configured user interface.

In accordance with the invention as embodied and broadly described herein, the present invention also resides in a touch-based input device comprising an input receiving element having a touch sensitive contacting surface adapted to receive an applied force; a sensor operable to detect and to facilitate determination of at least a location and/or magnitude of the applied force; and at least one static component disposed about the input receiving element, the touch-based input device being adapted to detect a force applied to the static component in any direction.

In accordance with the invention as embodied and broadly described herein, the present invention specifically resides in a force-based input device comprising a first structural element supported in a fixed position; a second structural element operable with the first structural element, and dynamically supported to be movable with respect to the first structural element to define a sensing element configured to displace under an applied force; a plurality of isolated beam segments joining the first and second structural elements, the isolated beam segments being operable to transfer forces between the first and second structural elements resulting from displacement of the sensing element; at least one sensor operable to measure strain within each of the isolated beam segments resulting from the transfer of forces and the displacement of the sensing element, each of the sensors being configured to output a signal, corresponding to the applied force and the measured strain, to be used to determine a location of the applied force on the sensing element; and a static component supported about the sensing element that receives and transfers the applied force to the sensing element to facilitate or cause the displacement of the sensing element, thus registering a force, the force-based input device operating to sense the static component and to determine a location of the applied force on the component, which registers substantially the same coordinates as if the force were being applied directly to the sensing element.

In accordance with the invention as embodied and broadly described herein, the present invention resides also in a method for reconfiguring a user interface within a touch-based input device, the method comprising disposing a static component at a first location about an input receiving element to at least partially define a first user interface; receiving an applied force about at least one of the static component and the input receiving element; sensing the applied force to determine at least a location of the applied force; and relocating the static component to a second location about the input receiving element to at least partially define a second configured user interface.

### BRIEF DESCRIPTION OF THE DRAWINGS

The present invention will become more fully apparent from the following description and appended claims, taken in conjunction with the accompanying drawings. Understanding that these drawings merely depict exemplary embodiments of the present invention they are, therefore, not to be considered limiting of its scope. It will be readily appreciated that the components of the present invention, as generally described and illustrated in the figures herein, could be arranged and designed in a wide variety of different configurations. Nonetheless, the invention will be described and explained with additional specificity and detail through the use of the accompanying drawings in which:

FIG. 1 illustrates one embodiment in accordance with the present invention comprising of a touch-based input device having movable and interchangeable static components;

FIG. 2 illustrates a cross-sectional side view of an embodiment of a touch-based input device having movable and interchangeable static components, where magnets are disposed within an input receiving element of the touch-based input device and are used to attach the static components to the input receiving element in accordance with one embodiment of the present invention;

FIG. 3 illustrates an embodiment of a static component for use with a touch-based input device, the static component having specific touch or input zones in accordance with one embodiment of the present invention;

FIG. 4 illustrates a side view of an embodiment of a touch-based input device, where static components are disposed on either side of an input receiving element in accordance with one embodiment of the present invention;

FIG. 5 illustrates a side view of an embodiment of a touch-based input device having a projected touch sensitive panel coupled to an input receiving element, and having a static component disposed on the projected panel in accordance with one embodiment of the present invention;

FIG. 6 illustrates a cross-sectional side view of an embodiment of a touch-based input device where a static component is disposed on one side of an input receiving element in accordance with one embodiment of the present invention;

FIG. 7 illustrates a touch-based input device having a static component disposed on an input receiving element of the touch-based input device in accordance with one embodiment of the present invention;

FIG. 8 illustrates a side view of the embodiment of FIG. 7;

FIGS. 9a-9b illustrate side views of examples of a touch-based input device having a three-dimensional input receiving element in accordance with one embodiment of the present invention;

FIG. 10 illustrates a touch-based input device having static components of various shapes, sizes, and materials in accordance with one embodiment of the present invention;

FIG. 11 illustrates a method for reconfiguring a user interface within a touch-based input device;

FIG. 12 illustrates a force-based input device in accordance with one embodiment of the present invention; and

FIG. 13 illustrates a force-based input device in accordance with one embodiment of the present invention.

### DETAILED DESCRIPTION OF EXEMPLARY EMBODIMENTS

The following detailed description of exemplary embodiments of the invention makes reference to the accompanying drawings, which form a part hereof and in which are shown, by way of illustration, exemplary embodiments in which the invention may be practiced. While these exemplary embodiments are described in sufficient detail to enable those skilled in the art to practice the invention, it should be understood that other embodiments may be realized and that various changes to the invention may be made without departing from the spirit and scope of the present invention. Thus, the following more detailed description of the embodiments of the present invention is not intended to limit the scope of the invention, as claimed, but is presented for purposes of illustration only to describe the features and characteristics of the present invention, and to sufficiently enable one skilled in the art to practice the invention. Accordingly, the scope of the present invention is to be defined solely by the appended claims.

The following detailed description and exemplary embodiments of the invention will be best understood by reference to the accompanying drawings, wherein the elements and features of the invention are designated by numerals throughout.

The present invention describes a touch-based input device which comprises, in part, an input receiving element having a touch sensitive contacting surface adapted to receive an applied force; a sensor operable to detect and to facilitate determination of at least a location of the applied force; and at least one static component disposed about the input receiving element. A touch-based input device and method is provided wherein the static component is removable from a first location to a second location to reconfigure the user interface to one of many possible choices. A touch-based input device is provided wherein the device detects a force applied to the static component in any direction.

The static components are designed and intended to expand the functionality of the touch-based input device, as well as to introduce and provide new and exciting interfaces that are operable with the input device. The static components may provide an aesthetic function, a utility function, a tactile function, or a combination of any of these and others. Indeed, rather than simply providing a planar, rigid touch surface as found in prior related input devices, particularly those that are not of the force-based type, the present invention introduces and creates enhanced user interfaces (e.g., different materials, three-dimensional surfaces, etc.) not possible with other input devices. The concept of incorporating a wide variety of “attachments” or “components” is, in general, one of the unique features of the present invention.

The static components may be sensed by a sensor operable with an input receiving element (in some embodiments, the sensor and input receiving element comprise a single element/material (e.g., piezoelectric sensors)), wherein the static components transfer a registered force to the sensing element or input receiving element (used interchangeably herein) causing the sensing element or input receiving element to displace and register the force to effectuate determination of the location of the applied force. In a static embodiment, the component has no moving parts. Examples of static components include, but are no way limited to, monolithic or non-moving buttons or keys, speakers, architectural features (filigrees, accents, etc.), projected panels, and others. Moreover, static components may include surface irregularities, such as a plurality of peaks and valleys integrally formed in the surface of the input receiving element. From the description herein, those skilled in the art will recognize that many other specific static components are possible.

Generally speaking, a component can be attached or mounted to either side of the touch-based input device using any suitable means. The ability to have penetrations within the touch-based input device allows something as simple as a clear through hole with a bolt and nut. This ability is discussed in more detail in U.S. patent application Ser. No. ______, filed concurrently herewith, and entitled “Force-Based Input Device with Boundary Defining a Void” (assigned Attorney Docket No. 02089-32356.NP4), which is incorporated by reference in its entirety herein. Static components, including projected components or panels, can also be removably coupled, or coupled with temporary means, allowing for simple and quick relocation or replacement.

The present invention provides several significant advantages over prior related input devices, some of which are recited here and throughout the following more detailed description. First, the present invention provides a method and device for an input device with a reconfigurable user interface where parts of the interface (various static components) may be moved or relocated and may provide similar or different functionality in a plurality of locations on the device. Second, the present invention provides a device which is capable of sensing, detecting, and/or registering a force applied to a component on the device, which also has not been capable in prior art devices.

Each of the above-recited advantages will be apparent in light of the detailed description set forth below, with reference to the accompanying drawings. These advantages are not meant to be limiting in any way. Indeed, one skilled in the art will appreciate that other advantages may be realized, other than those specifically recited herein, upon practicing the present invention.

The term “touch sensitive,” as used herein, shall be understood to mean any surface of any element or component operable with the touch-based input device of the present invention capable of receiving an applied force and facilitating or causing detection of said applied force by said sensing element. A touch sensitive contacting surface may be provided by the contacting surface of the input receiving element and/or the contacting surface(s) of any static component upon being properly disposed about the input receiving element.

The term “input receiving element,” or “sensing element,” as used herein, shall be understood to mean that element capable of detecting an applied force occurring about the input device, and measuring one or more characteristics or corresponding attributes of the applied force. The sensing element functions to detect and measure the applied force, or a characteristic or corresponding attribute pertaining thereto, thus facilitating the determination of the location, magnitude and/or profile of the applied force about the contacting surface. Specifically, the sensing element may comprise one or more sensors operable therewith, or alternatively be formed of a sensing material (e.g., piezoelectric), that senses or measures a characteristic or corresponding attribute of the applied force, and outputs various data signals that can be received and processed by one or more processing means. These data signals are intended to facilitate the determination of the location, magnitude and/or profile of the applied force about the contacting surface.

### Input Device

The present invention static components are intended to be operable with input devices, and particularly with force-based input devices. While specific reference is made herein to a particular configuration of a force-based input device, it is understood that any touch-based input device is contemplated for use herein comprising an input receiving or sensing element (including force sensors) which generates a signal in response to a touch from an external stimulus. Although force-based input devices are more particularly set forth herein, examples of other types of touch-based input devices include, but are not limited to, resistive-based input devices, capacitance-based input devices, surface acoustic wave-based devices, and infrared-based devices.

In one aspect of the invention, a force-based input device comprises a first, mounted or stationary structural support member, and a second, dynamic structural support member that moves or displaces with respect to the first structural support member, wherein the second, dynamic structural support member comprises a sensing element designed to receive and register forces applied to its surface, either directly or indirectly. Direct application of force would mean that the force is acting directly on the surface of the sensing element. Indirect application of force would mean that the force is acting on another object or surface, but that the applied force is sufficiently transferred to the sensing element to cause the force to register as if it were applied directly to the sensing element itself. For instance, in the case of a functional attachment that is sensed by the sensing element, the force-based input device is capable of registering and determining a location of a force that is applied on the functional attachment. The force acting on the functional attachment, and that is transferred to the sensing element, registers about substantially the same coordinates as if the force were being applied directly to the sensing element. This is made possible by the configuration of the force-based input device being used.

Within the force-based input device, the sensing element may comprise many different types and configurations. For example, the sensing element may comprise any of those described in U.S. application Ser. No. 11/402,694, filed Apr. 11, 2006, and entitled, “Force-based Input Device;” as well as U.S. application Ser. No. 11/888,673, filed Jul. 31, 2007 and entitled, “Force-Based Input Device Having an Elevated Contacting Surface;” and U.S. application Ser. No. 12/002,334, filed Dec. 14, 2007, and entitled, “Force-Based Input Device Having a Modular Sensing Component,” each of which are incorporated by reference in their entirety herein.

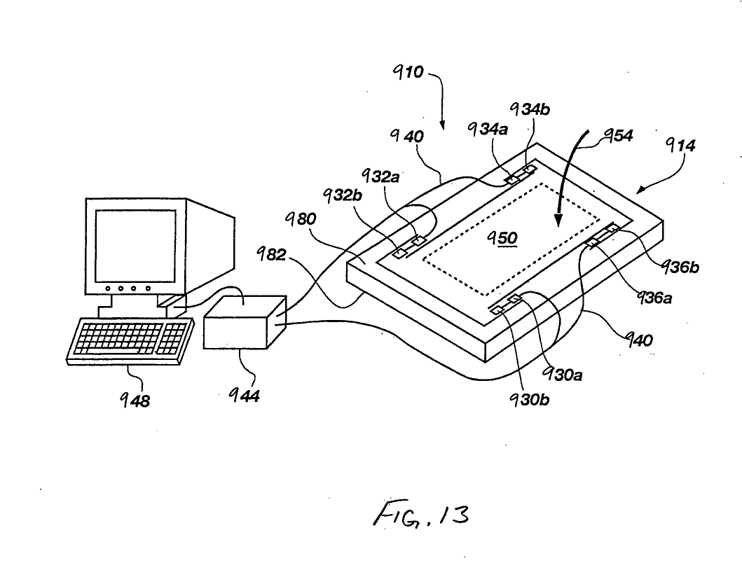

In one exemplary embodiment, with reference to FIGS. 12 and 13, shown is a force-based input device 910. The input device 910 can have a first structural member in the form of a base support 914 having an outer periphery 918. A plurality of apertures 920, 922, 924, and 926 can be formed in the base support 914 within the periphery 918. The apertures 920, 922, 924, and 926 can be located along the periphery 918 and can circumscribe or define a second structural member in the form of an input pad or sensing element 950 that is movable with respect to the first structural member or base support 914 in response to an applied load.

The plurality of apertures can also define a plurality of isolated beam segments, 930, 932, 934, and 936, near the corners of, and parallel to the sides of the sensing element 950. Two sensors (see sensors 930a, 930b, 932a, 932b, 934a, 934b, 936a and 936b) can be attached along each isolated beam segment 930, 932, 934, and 936, respectively. The sensors 930a, 930b, 932a, 932b, 934a, 934b, 936a and 936b are configured to detect and measure a force applied to the sensing element 950. In addition, the sensors 930a, 930b, 932a, 932b, 934a, 934c, 936a and 936b are configured to output an electronic signal through a transmission device 940 attached or otherwise related to the sensors 930a, 930b, 932a, 932b, 934a, 934b, 936a and 936b, which signal corresponds to the applied force as detected by the sensors.

In one exemplary embodiment, the sensors 930a, 930b, 932a, 932b, 934a, 934c, 936a and 936b each comprise a strain gage configured to measure the strain within or across each of the respective isolated beam segments 930, 932, 934, and 936. Moreover, although each isolated beam segment 930, 932, 934, and 936 is shown comprising two sensors located or disposed thereon, the present invention is not limited to this configuration. It is contemplated that one, two or more than two sensors may be disposed along each of the isolated beam segments depending upon system constraints and other factors. In addition, it is contemplated that the sensors may be comprised of the beam segments themselves, if appropriately configured. The sensors are discussed in greater detail below.

The transmission device 940 is configured to carry the sensors' output signal to one or more signal processing devices, shown as signal processing device 944, wherein the signal processing devices function to process the signal in one or more ways for one or more purposes. For example, the signal processing devices may comprise analog signal processors, such as amplifiers, filters, and analog-to-digital converters. In addition, the signal processing devices may comprise a micro-computer processor that feeds the processed signal to a computer, as shown in FIG. 13. Or, the signal processing device may comprise the computer 948, itself. Still further, any combination of these and other types of signal processing devices may be incorporated and utilized. Typical signal processing devices are known in the art and are therefore not specifically described herein.

Processing means and methods employed by the signal processing device for processing the signal for one or more purposes, such as to determine the coordinates of a force applied to the force-based touch pad, are also known in the art. Various processing means and methods are discussed in further detail below.

With reference again to FIGS. 12 and 13, the base support 914 is shown comprising a substantially flat, or planar, pad or plate. The base support 914 can have an outer mounting surface 960 and an inner mounting surface 964 that can lie essentially within the same plane in a static condition. The outer mounting surface 960 can be located between the periphery 918 and the apertures 920, 922, 924, and 926. The inner mounting surface 964 can be located between the sensing element 950 and the apertures 920, 922, 924, and 926. The isolated beam segments 930, 932, 934, and 936 can connect the inner mounting surface 964 with the outer mounting surface 960. The outer mounting surface 960 can be mounted to any suitably stationary mounting structure configured to support the input device 910. The sensing element 950 can be a separate structure mounted to the inner mounting surface 964, or it may be configured to be an integral component that is formed integrally with the inner mounting surface 964. In the embodiment where the sensing element is a separate structure, one or more components of the sensing element can be configured to be removable from the inner mounting surface. For example, the sensing element 950 may comprise a large aperture formed in the base support 914, and a removable force panel configured to be inserted and supported within the aperture, which force panel functions to receive the applied force thereon from either direction.

The base support 914 can be formed of any suitably inelastic material, such as a metal, like aluminum or steel, or it can be formed of a suitably elastic, hardened polymer material, as is known in the art. In addition, the base support 914 may be formed of glass, ceramics, and other similar materials. The base support 914 can be shaped and configured to fit within any type of suitable interface application. For example, the base support can be configured as the viewing area of a display monitor, which is generally rectangular in shape. In addition, the base support 914 can be configured to be relatively thin so that the touch surface of the sensing element of the base support is only minimally offset from the viewing area of a display monitor, thereby minimizing distortion due to distance between the sensing element and the display monitor.

It is noted that the performance of the input device may be dependent upon the stiffness of the outer portion or outer mounting surface of the base support 914. As such, the base support 914, or at least appropriate portions thereof, should be made to comprise suitable rigidity or stiffness so as to enable the input device to function properly. Alternatively, instead of making the base support 914 stiff, the base support 914, or at least a suitable portion thereof, may be attached to some type of rigid support. Suitable rigidity functions to facilitate more accurate input readings.

The sensing element 950 can be a substantially flat, or planar, pad or plate and can lie within the same plane as the base support 914. The sensing element 950 can be circumscribed by the apertures 920, 922, 924, and 926.

The sensing element 950 is configured to displace in response to various stresses induced in the sensing element 950 resulting from application of a force, shown as arrow 954 in FIG. 13, acting on the sensing element 950. The sensing element 950 is further configured to transmit the stresses induced by the applied force 954 to the inner mounting surface 64 and eventually to the isolated beam segments 930, 932, 934, and 936 where resulting strains in the isolated beam segments are induced and measured by the one or more sensors.

The base support 914 and sensing element 950 can have a first side 980 and a second side 982. The present invention force-based input device 910 advantageously provides for the application of force to either the first or second sides 980 and 982 of the sensing element 950, and the sensing element 950 may be configured to displace out of the plane of the base support 914 in either direction in response to the applied force 954.

The sensing element 950 can be formed of any suitably rigid material that can transfer, or transmit the applied force 954. Such a material can be metal, glass, or a hardened polymer, as is known in the art.

The isolated beam segments 930, 932, 934, and 936 can be formed in the base support 914, and may be defined by the plurality of apertures 920, 922, 924, and 926. The isolated beam segments 930, 932, 934, and 936 can lie essentially in the same plane as the base support 914 and the sensing element 950 when in a static condition. In some embodiments, the apertures 920, 922, 924, and 926 may be configured to extend all the way through the base support 914. For example, the apertures 920, 922, 924, and 926 can be through slots or holes. In other embodiments, the isolated beam segments 930, 932, 934 and 936 may be configured to extend only partially through the base support 914.

As illustrated in FIG. 12, the isolated beam segment 932 can be formed or defined by the apertures 922 and 924. Aperture 922 can extend along a portion of the periphery 918 and have two ends 922a and 922b. The aperture 924 can extend along another portion of the periphery and have two ends 924a and 924b. Portions of the two apertures 922 and 924 can extend along a common portion of the periphery 918 where one end 922b of aperture 922 overlaps an end 924a of aperture 924. The two ends 922b and 924a, and the portions of the apertures 922 and 924 that extend along the common portion of the periphery 918, can be spaced apart on the base support 914 a pre-determined distance. The portion of the aperture 922 that extends along the common portion of the periphery 918 can be closer to the periphery 918 than portion of the aperture 924 that extends along the common portion of the periphery 918. The area of the base support 914 between the aperture 922 and the aperture 924, and between the end 922b and the end 924a, can define the isolated beam segment 932.

The isolated beam segments 930, 934, and 936 can be similarly formed and defined as described above for isolated beam segment 932. Isolated beam segment 930 can be formed by the area of the base support 914 between the apertures 924 and 920, and between the ends 924a and 920a. Isolated beam segment 934 can be formed by the area of the base support 914 between the apertures 924 and 926, and between the ends 924b and 926b. Isolated beam segment 936 can be formed by the area of the base support 914 between the apertures 926 and 920, and between the ends 926a and 920b. Thus, all of the isolated beam segments can be defined by the various apertures formed within the base support 914. In addition, the isolated beam segments may be configured to lie in the same plane as the plane of the sensing element 950 and base support 914, as noted above.

The plurality of apertures 920, 922, 924, and 926 can nest within each other, wherein apertures 922 and 926 extend along the sides 990 and 992 of the rectangular base support 914, and can turn perpendicular to the short sides 990 and 992 and extend along at least a portion of the sides 994 and 996 of the base support 914. Apertures 920 and 924 can be located along a portion of the sides 994 and 996 of the base support 914 and closer to the sensing element 950 than apertures 922 and 926. Thus, apertures 920 and 924 can be located or contained within apertures 922 and 926. Stated differently, the apertures may each comprise a segment that overlaps and runs parallel to a segment of another aperture to define an isolated beam segment, thus allowing the isolated beam segments to comprise any desired length.

In another exemplary embodiment similar to that shown in FIG. 12, the sensing element may be located about the perimeter or periphery of the input device with the inner and outer mounting surfaces being positioned inside or interior to the sensing element. In other words, the force-based input device may be considered to comprise a structural configuration that is the inverse of the configuration shown in FIG. 12. This further illustrates that the present invention broadly contemplates a first structural element supported in a fixed position, and a second structural element operable with the first structural element, wherein the second structural element is dynamically supported to be movable with respect to the first structural element to define a sensing element configured to displace under an applied force.

### Static Components

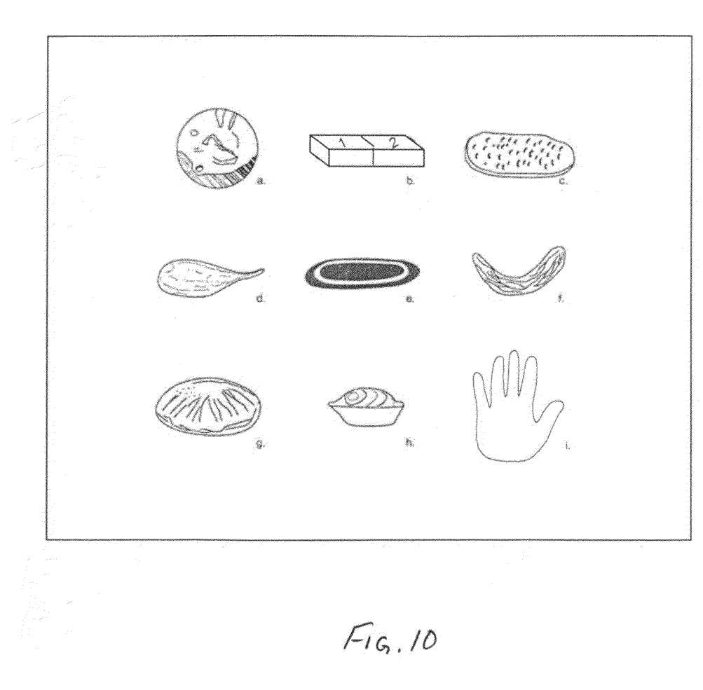

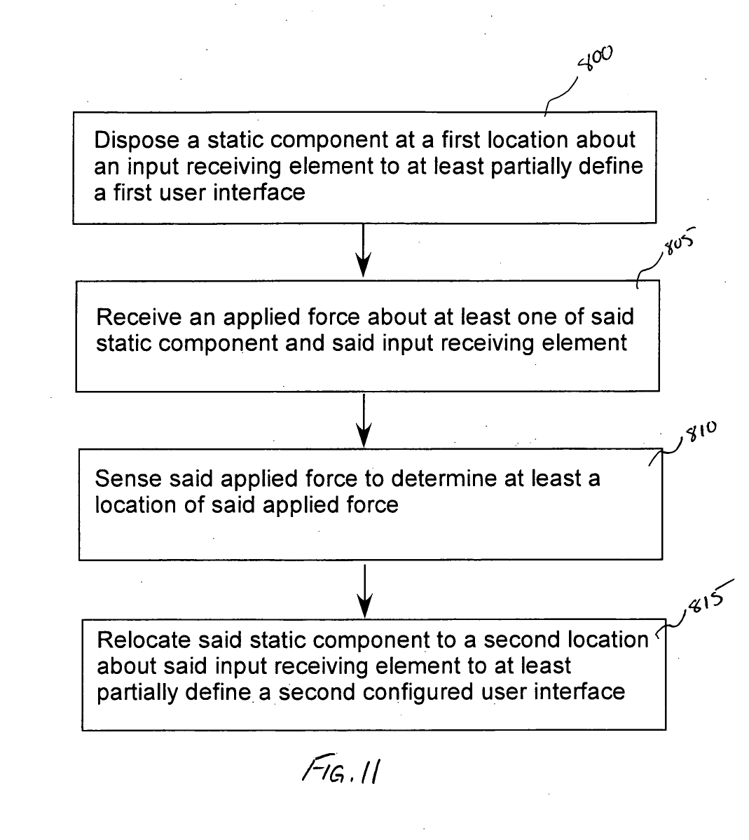

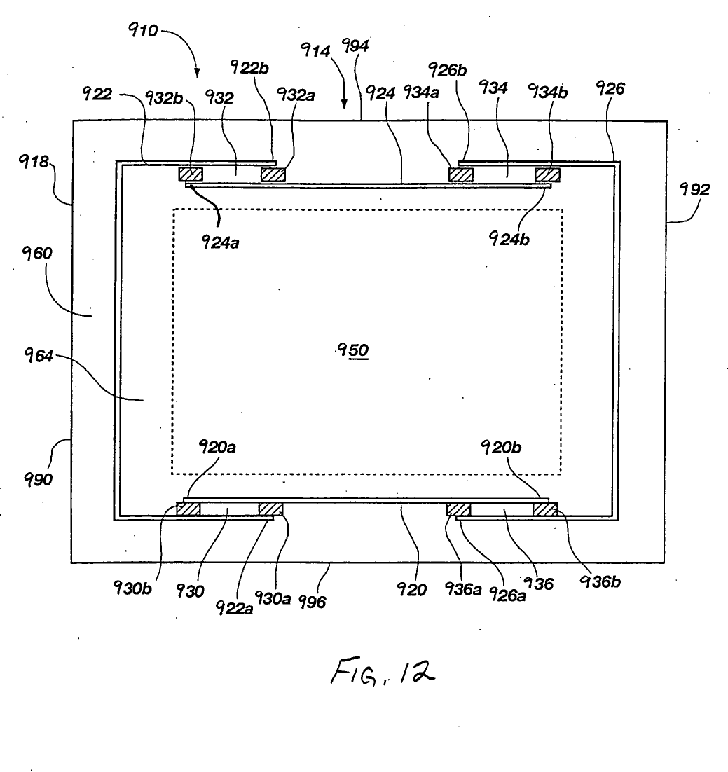

It is understood and contemplated herein that a number of objects (or static components) may be disposed about a touch-based input device, such as a force-based input device. FIG. 10 illustrates a few exemplary static components (shown as a through i) disposed about an exemplary input device. When the user touches an object disposed on the input device, the resulting forces are transmitted by the object to the input device. The applied forces will be distributed to the input device's sensors in such a way that the input device's signal conditioning can determine that the object was touched. While further reference is made herein to “attached” static components, it is understood that objects properly in contact with the touch-based input device are also contemplated, such as those movable about a track or within apertures formed in the input receiving element under influence of an external force, or those not necessarily coupled. That is, the static component need not be attached to the input device. Static components integrally formed with the input receiving element are also contemplated.

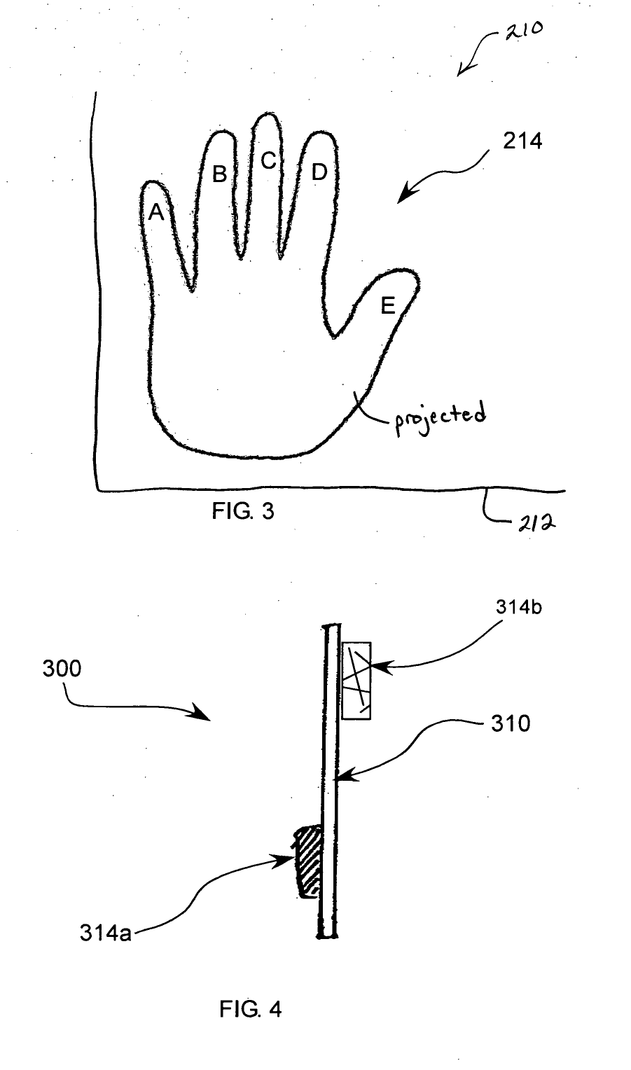

It is possible to determine where the attached static component was touched so that the static component may be subdivided into multiple touch sensitive areas (such as object b on FIG. 10 and input areas A-E on object 214 shown on FIG. 3). If more than one static component is attached to a force-based touch panel, the signal conditioning may distinguish which of the static components was touched. The location of the touches and the static component touched may be determined in the same manner as an ordinary flat force-based touch screen, without any special adaptation of the sensing method or location determining method. Static components that are attached to (or otherwise disposed on or integral with) a force-based touch screen become touch sensitive themselves because the touch sensing and locating method of force-based touch screens does not depend on the user interacting with electrical, magnetic, or electromagnetic fields, as in capacitive, infrared or optical touch screens; nor does it depend on perturbing the touch receiving surface locally, such as in surface acoustic wave, resistive or bending wave touch screens. The static components may have a variety of surface treatments such as coverings texture and materials to add variety to the user's interaction. The static components need not be permanently attached but may be secured with magnets, hook and loop fasteners or other semi permanent means. This allows for easy reconfiguration of the user interface. Portions of the static components may be delineated by means of texture, type of material, graphics, tactile features, or shape. The various portions may be made to perform different functions for the user.

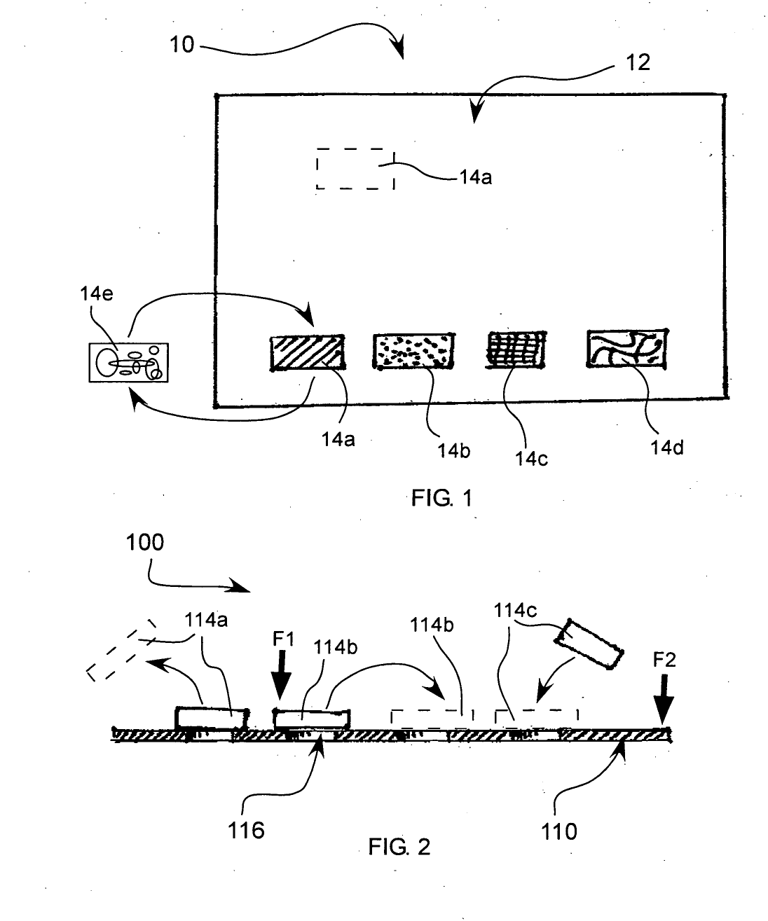

Referring to FIG. 1, a touch-based input device 10 may comprise a sensing element 12 (also referred to herein as “sensing element”) having a sensing surface. It is noted that the sensing element 12 shown in FIG. 1 is a single sensing element, with each of the components 14a-14e shown being supported thereon. Of course, the touch-based input device may comprise multiple sensing elements, each operable with one another and any corresponding static components. Further, there may be a single static component or multiple static components operable with the device. It is important to note that the present invention may comprise many different static components, such as those shown on FIG. 10. Other possibilities are shown and described herein. Some of these are made possible by force-based technology of the input device.

Use of one or more static components will increase the overall static mass of the input device. This increase in static mass is intended to be accounted for during calibration and recalibration of the device, whether the calibration be manual or automatic. For example, the overall static mass of the input device fluctuates with the addition or removal of a component. As such, the device can be recalibrated to account for this fluctuation of static mass, and to enhance the accuracy of the reported readings from the input device with respect to the location of the applied force.

In one embodiment of the present invention, the touch-based input device may comprise a projected component having an input or contact surface, and may further comprise specific touch zones upon that surface (shown in FIG. 3 as input touch zones A-E). The particular projected component is intended to be sensed by the sensing element, and may have no moving parts, thus being static. One notable difference, however, is that the projected component operates with a smaller portion of the entire sensing element of the input device. Nonetheless, the projected component comprises a contacting element or input surface that is located in a projected position with respect to, or that is projected outward or away from, the sensing surface of the sensing element. The input surface is supported by one or more transfer elements (not shown) that function to support the input surface and to transfer the applied force from the projected component to the sensing element. Stated differently, the input surface lies in a contact plane that is different from the sensing plane in which the sensing element lies. The input surface in this case is not the surface sensing the applied force, but is rather the surface that receives the applied force that is subsequently transferred to the sensing surface and the sensing element. As such, the input surface is allowed to be located in a projected position away from the sensing element.

In embodiments such as that shown in FIG. 3, the input device 210 comprises a sensing element 212, and a projected component 214 that is a single structure having a single input surface. The projected component 214 may comprise multiple or a plurality of differentiated touch zones (A-E). Therefore, each of the touch zones is separate and distinct from the other, and can be used to perform or control different functions depending upon which one is selected and a force applied thereto. Upon applying a force to any one of the touch zones, a corresponding force is transferred to the sensing element, which force registers along the same coordinates of the sensing element just as if the force was applied directly to the surface of the sensing element. It is noted also that the projected component 214 may comprise a plurality of input surfaces. In addition, the projected component 214 may be removable and relocated to another or second position about the sensing element to provide a different function, or it may be interchanged with another projected component or an entirely different static component.

An additional advantage of one embodiment of the present invention is that the sensing element is capable of registering forces applied on both of its sides. That is, it makes no difference whether forces are applied to the top or bottom, or alternatively front or back, surfaces of the sensing element. Either way, the sensing element is capable of registering these. This adds yet another layer of potential functionality not available in prior related input devices. In one exemplary embodiment of the present invention shown in FIG. 4, a static component 314a or 314b may be disposed on more than one side of the input receiving element 310 of the touch-based input device 300. This allows for multiple user interfaces, which may be configured by a user.

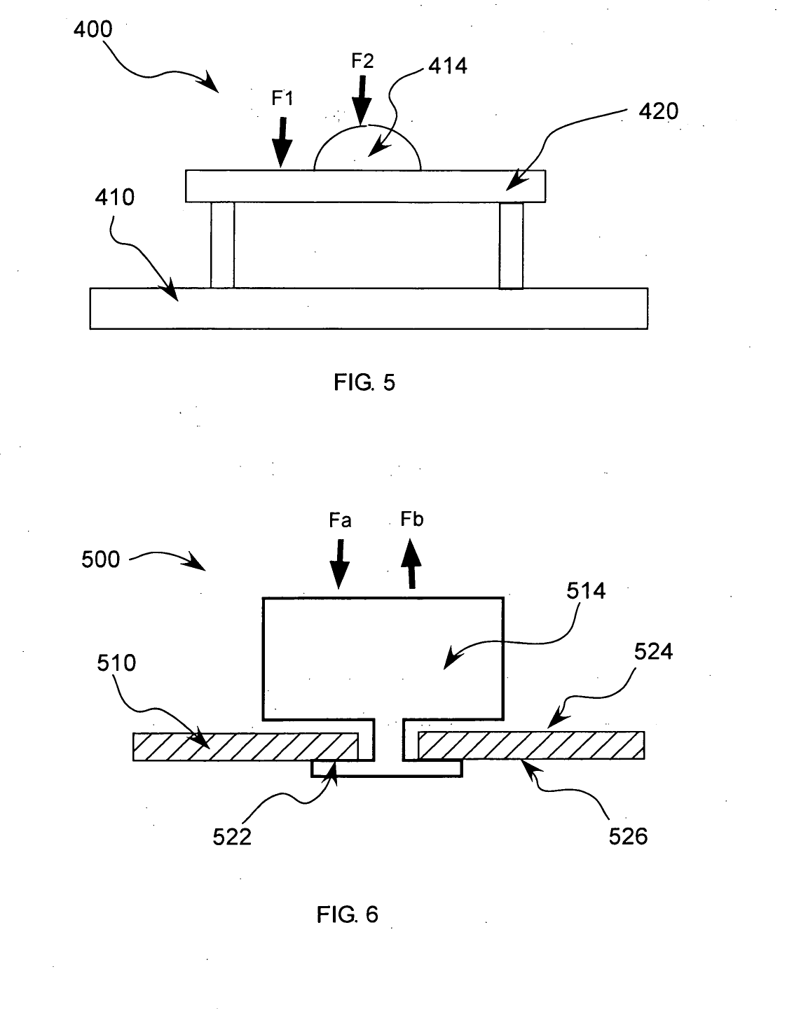

Referring to FIG. 4-5, the touch-based input device 300 or 400 may comprise a projected surface. The projected surface may be part of a projected panel or other touch sensitive surface 420 as in FIG. 5, or part of a static component 314a-314b or 414 as in FIG. 4-5. The particular projected surface is intended to be sensed by the sensing element, but has no moving parts, thus being static. Again, the projected surface is located in a projected position with respect to, or that is projected outward or away from, the surface of the sensing element.

The touch-based input device may comprise a second projected component, which also has a contact surface and a plurality of touch zones. This projected component may be of the same type and function in a similar manner as the projected components discussed above. In one embodiment shown in FIG. 5, there is a projected panel 420 having a touch sensitive surface about which an additional static component 414 may be disposed. The panel is projected from an input receiving element 410, and forces F₁ or F₂ applied to the projected panel 420 or component 414 are transferred directly to the input receiving or sensing element 410. As in other embodiments, the static component 414 may be removable and repositionable to a second location on the touch sensitive surface of the projected panel, or to the surface of the sensing element itself.

The touch-based input device may further comprise a plurality of static components in the form of push buttons, keys, etc. that are intended to be sensed by the sensing element. These particular types of static components introduce a variety of functional and/or aesthetically pleasing user interface options rather than simply providing an identified touch zone on the sensing surface of the sensing element where a user applies a force directly to the sensing surface. These static components function to transmit forces to the sensing element much in the same way as discussed above. The components may comprise a physical makeup and configuration different from the contacting surface of the input receiving element.

There are many different types of components possible, including, but not limited to, simple blocks of material providing a monolithic structure (i.e., acting as a single, rigid, uniform whole), tactile devices (e.g., tactile push buttons, keys, objects, etc.), rigid structures having flexible or decorative three-dimensional overlays, simple flexible materials attached to the sensing element, etc. For example, in one exemplary embodiment, the touch-based input device comprises a push-button having a rigid base enclosed by fabric on one end and leather on the other. The input device may comprise a push-button having a rigid base and a neoprene covering. Alternatively, rather than providing a monolithic push button or key, a tactile feedback device may be used, such as a tactile feedback push button. Examples of various component structures are illustrated in FIG. 10.

Referring back to FIG. 1, in accordance with one embodiment of the present invention, static components 14a-14e each comprise a different material makeup. Each of these different types comprise an input surface, and at least some degree of rigidity in order to transfer the forces applied to the respective input surfaces of the components to the sensing element where a force can be registered. Some contemplated examples of rigid materials from which to form a static component include stone, metal, plastic, laminate, glass, composite, and any combination of these.

Alternatively, static components having input surfaces that are to receive an applied force do not need to comprise a rigid component. While the basic sensing element or projected panel will normally be rigid, it can be covered entirely, or in select areas, with non-rigid materials such as leather, cloth, neoprene, fur, etc. Or, as noted above, it can be covered with multiple layers of a non-rigid material, such as several layers of thin polycarbonate. The effect of non-rigid, flexible surfaces may be the same as multiple layers in that it may reduce the accuracy of the reported touch location. However, if the touch zone, as defined in the software, is adequately large relative to the actual touch zone on the component as communicated to the user either physically or visually, and the relative softness or number of layers employed is not too restricting, the input device will operate satisfactorily.

Referring now to FIGS. 1-2, another feature that may be illustrated is that the present invention contemplates removable and interchangeable static components 14a-14e and 114a-114c. Indeed, each of these components may be removably coupled and supported about the sensing element 12 or 110, thus facilitating their being repositioned or interchanged as needed or desired. Although the projected components are shown as being mounted to the sensing element using mounting means such as bolts, screws, etc., these too can be removably attached or coupled to the sensing element. Removably coupling and supporting a component may be accomplished using any known means, such as an adhesive, a magnet, a hook and loop fastener, a snap or snap-like fastener, a zipper, and any others known in the art. More permanent means are also contemplated, such as using bolts or screws. FIG. 2 shows magnets 116 embedded in a void within the input receiving element 110, where the magnets 116 and components 114a-114c are magnetically attracted to one another.

Further, where a static component 14a is interchangeable with another static component 14e, the second static component 14e may be disposed in the location of the first 14a. A further variation on this is that in a device with two static components, one static component may be attached to, or supported about, the other static component to further enhance user interaction or the user interface. As shown in FIG. 1, the user interface may be customized by a user by repositioning or interchanging various static components, such as exchanging component 14a with 14e, or moving static component 14a to another location on the input receiving element 12. FIG. 2 shows static components 114a-114c being removed 114a, put into position 114c, and relocated from another position 114b.

Referring back again to FIG. 1, in accordance with one embodiment of the present invention, a touch-based input device 10 is provided having a reconfigurable user interface. The touch-based input device 10 further comprises an input receiving element 12 having a touch sensitive contacting surface as part of a first configured user interface adapted to receive an applied force. A sensing element operable to detect and to determine at least a location of said applied force is also part of the touch-based input device. Furthermore, at least one static component (shown as 14a-14e) is removably disposed at a first location about said input receiving element 12. The static component disposed about the input receiving element 12 is adapted to at least partially define the first configured user interface. Additionally, said static component 14a-14e is movable to a second location about said input receiving element to reconfigure said user interface and to at least partially define a second configured user interface. As described above, disposal of the static component about the input receiving element can cause the static component to become touch sensitive as the component may transfer applied forces received thereon to the sensing element. Indeed, the component itself becomes touch sensitive upon being disposed about said input receiving element without external interaction with the sensing element. Thus, as shown in FIG. 2, a user can touch (depicted as force F₁) a component 114b or touch (depicted as force F₂) the input receiving element 110.

In one aspect of the invention, the touch-based input device may be arranged in a first configured user interface which will perform substantially the same functionality as when the touch-based input device is arranged in said second configured user interface. That is, static components may be rearranged on the contacting surface yet still maintain the same functionality. Alternately, the touch-based input device may be arranged in a first configured user interface which will perform a substantially different functionality as when the touch-based input device is arranged in said second configured user interface. In other words, the device may be configured such that whether the user interface is in a first or second configuration, it operates in the same or a different manner.

A static component may be electromechanically detected by the device. That is, the device may be configured to recognize a specific component by the weight or position of the component on the input receiving element. Further, the component may be detected by means of electronic or magnetic signals resulting from placing the component on the input receiving element. Alternatively, the input receiving element may comprise levers, switches, or other mechanical means which are triggered or perform some function when the static component is caused to engage them.

In one aspect of the invention, the input receiving element may comprise a void configured to receive one or more shapes or types of components. This void may be configured with electromechanical means as described above which can detect features of a component, such as a shape by virtue of the edges of the static component triggering certain mechanisms indicating to the touch-based input device the shape or configuration of the component. A component with a different shape may trigger different mechanisms so that the device can recognize characteristics of the different component. Such features or characteristics of the components may be pre-programmed into the device.

Alternatively, a user configuration may be manually input or customized by a user. Where a touch-based input device may have multiple uses or functionality, a user can indicate which function the user wishes to operate by reconfiguring the user interface to his/her liking based on the placement of one or more static components. This can be done by a variety of means including, but not limited to, touching a certain region on the input receiving element, pressing a button, giving a voice command, toggling a switch, or the like. Once the desired functionality has been selected, the device may then recognize the components as performing differing functions from what was performed in the previous mode. It is recognized that some functionality in the new mode may remain the same. The components may be relocated to accomplish the new functionality, or they may remain as they were in the previous mode.

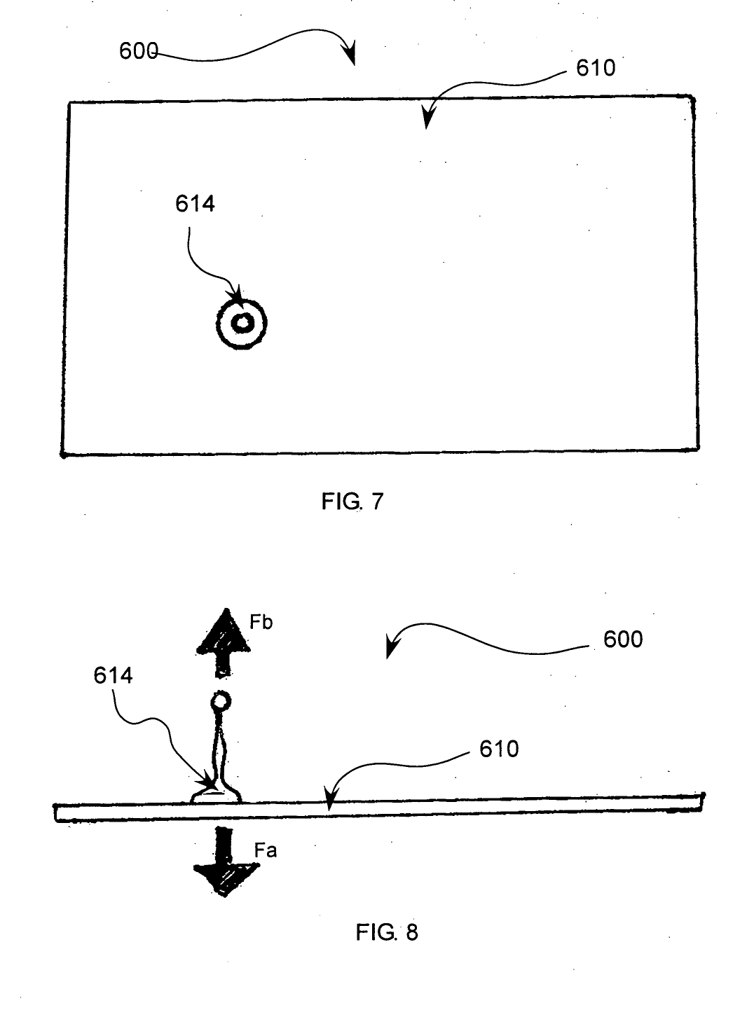

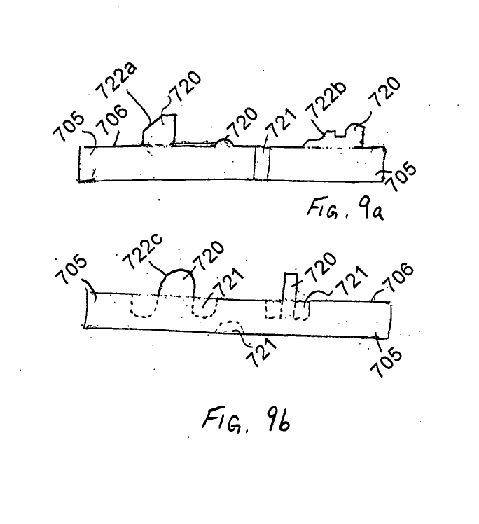

With reference to FIGS. 7-8, the present invention includes a touch-based input device 600 comprising an input receiving element 610 having a touch sensitive contacting surface adapted to receive an applied force (represented by arrows F_{A} or F_{B}) and a sensing element operable to detect and to determine at least a location of said applied force. The input device further comprises at least one static component 614 disposed about said input receiving element 610. Said touch-based input device 600 is adapted to detect a force applied to said static component 614 in any direction. In one aspect, a user may press or pull on the static component 614 and the input device may be adapted to detect the force applied to the component 614. Some of the detectable attributes regarding this force may include the degree of force applied and/or the location of the force. In this embodiment, the static component may be permanently attached to the input receiving element or it may be removable.

In one aspect, where the static component is removable, the device may recognize a force applied to the static component up until the static component has separated from the device. In one embodiment shown in FIG. 2, a static component 114a-114c may be coupled to the device 100 by magnetic means 116. When a small amount of force is applied to the static component pulling it away from the device, the magnetic force may be strong enough to maintain the connection between the static component and the input receiving element. The device may then detect the force up until the point where the force pulling on the static component exceeds the magnetic force and the static component separates from the input receiving element. In another aspect, the touch-based input device may be calibrated to detect non-touching forces, such as the force of a magnet pushing or pulling against the input receiving element. This may be useful, for instance, where it is not desirable to have the touch-based input device operable by direct physical touch. A panel or substrate, such as a piece of glass, may be placed in front of the input receiving element, but not be coupled thereto, such that any touch, force, or other contact with the substrate registers no force on the input receiving element. However, a user holding a magnet may place or hold the magnet in a desired location on or near the substrate such that the magnet causes a force through the substrate which registers on the input receiving element.

In reference to FIG. 6, in one aspect, the touch sensitive surface 510 further comprises a front surface 524 and a back surface 526, and the static component 514 may be disposed on the front surface 524 and include a portion that passes through the touch sensitive surface 510 and attaches to the back surface at 522 such that when a force is applied to the static component 514, said force is transferred through said static component 514 and applied to the back surface 526 through the attachment 522. In this configuration, the interface may not appear to a user to function differently than where the component 514 is attached to the front surface 524. However, the actual functionality is different. In an example where a user presses in the direction F_{A} on the component 514, a force F_{A} is not transferred through the component 514 to the front surface 524. Rather, the force F_{A} is transferred through the portion of the component 514 to the back surface attachment 522. Thus, when a user presses on the component 514, this causes a force F_{A} pulling away from the back surface 526. When a user pulls on the component 514, there is a force F_{B} pressing against the back surface 526.

With reference now to FIG. 11, the present invention further includes a method for reconfiguring a user interface within a touch-based input device. The method comprises the step of disposing a static component at a first location about an input receiving element to at least partially define a first user interface 800 and receiving an applied force about at least one of said static component and the input receiving element 805. The method further comprises sensing the applied force to determine at least a location of the applied force 810 and relocating the static component to a second location about the input receiving element to at least partially define a second configured user interface 815.

The method may further comprise configuring the touch-based input device such that the static component provides a touch sensitive contacting surface upon disposal about the input receiving element without external interaction with the sensing element. The method may further comprise determining the location of the applied force in the same manner without adaptation of either one of a sensing and a location determining method of the touch sensitive device, whether the applied force is about the contacting surface of the input receiving element or about the contacting surface of the static component. The method may further comprise interchanging the static component with a second static component, wherein the second static component may be disposed about either of the first and second locations about the input receiving element.

In operation, at least some of the above-described static components, and any others that might be used, operate as intended due to an underlying force-based technology in a force-based input device. Specifically, applied forces are applied directly to the sensing surface of the sensing element, or to an input surface of a component, are transferred to the isolated beam segments of the force-based input device. This technology permits actual touch or input surfaces to be located in a different plane than the sensing element, whether above or below the sensing element. The signals generated by the applied forces within these planes are processed in a similar manner as those generated by application of forces directly on the sensing surface of the sensing element. Any changes in sensitivity resulting from application of force a distance away from the actual sensing surface of the sensing element may be accounted for in the signal processing and the software used to determine the location of the applied force.

The sensing element may comprise a plurality of holes, apertures, indentations and the like of different size and location. These too do not disrupt the force-sensing capabilities of the force-based input device. The sensing element can have any number and arrangements of holes or cut-out areas, to the point it could be a simple filigree design. Likewise, any projected component may also have any number and arrangement of holes or cut-out areas. This has significant implications, namely that applying a force to the sensing surface of the sensing element, or the input surface of a projected component or panel, where there is no hole or cut out area will operate the device and register a force just as if the sensing element were a solid structure (presuming it remains reasonably rigid). In addition, various holes or cut-outs would allow operation of a device behind the cutout area without registering a force or causing operation of the force-based input device.

Holes or cut-outs can be formed in the sensing element or projected component for any number of purposes. For example, holes or cut-outs can be formed for the purpose of receiving screws or bolts that facilitate the coupling of various objects or items to the sensing element, for providing windows for displays, for facilitating operation of or access to sub-lying devices such as switches, adjustment potentiometers, etc.

Referring now to FIGS. 9a and 9b, in accordance with one embodiment of the present invention, a force-input device is shown having a sensing element 705 comprising a three-dimensional surface 720 disposed on or integrally part of the force sensing element 705. The three-dimensional surface acts to transfer an applied force to the force sensors associated with the sensing element 705 as with other applied forces described herein. As shown, voids 721 may be present within the sensing element together with the three-dimensional surface 720. In one aspect of the invention, a force applied to any surface of the three-dimensional surface 720 may be registered on the force sensing element 705. This includes forces applied in a direction which is not normal to a front surface 706 of the sensing element 705. For example, a force applied on surface 722a, 722b, and/or 722c would still register a force on the sensing element 705 as the force has a normal force component acting on the sensing element 705. In general, most external forces applied to an object associated with the sensing element 705 will have a normal component and are capable of being measured by the force-input device.

The projected component may be designed and intended to operate with switches. By touching the input surface of the projected component in one of the touch zones, indicators such as audio or visual indicators, or both, may report to the user what was touched or selected. These switches can in part control the function of the static component. For example, with a switch in an upward position, touching the static component or a particular zone on the static component will cause the sensing element to register this force, which may in turn prompt a sound file to be played out of a speaker, indicating to the user the word “apples” in the English language. In addition, an image of apples appearing on the input surface of the projected component may be caused to be displayed on the display as further indicia of the selected touch zone. By flipping the switch, the user can change the language heard from the speakers. This is just one example of the possibilities associated with this embodiment and configuration. Other possibilities, configurations, and embodiments will be apparent to one having skill in the art.

The switches, like the display, may be actually mounted to the sensing element, and are not sensed by the sensing element even though they are dynamic or movable in part. The mounting of the switches does not interfere with the operation of the sensing element. In this particular embodiment, the switches are not intended to register a force on the sensing element upon being switched, but may be instead electrically controlled as known in the art. However, it is contemplated that one or more switches may be used with the touch-based input device that are configured to be sensed, wherein they apply a registered force on the sensing element, and wherein flipping the switch back and forth causes a different force location to be registered, which different registered forces control the “switching” function of the switches.

The foregoing detailed description describes the invention with reference to specific exemplary embodiments. However, it will be appreciated that various modifications and changes can be made without departing from the scope of the present invention as set forth in the appended claims. The detailed description and accompanying drawings are to be regarded as merely illustrative, rather than as restrictive, and all such modifications or changes, if any, are intended to fall within the scope of the present invention as described and set forth herein.

More specifically, while illustrative exemplary embodiments of the invention have been described herein, the present invention is not limited to these embodiments, but includes any and all embodiments having modifications, omissions, combinations (e.g., of aspects across various embodiments), adaptations and/or alterations as would be appreciated by those skilled in the art based on the foregoing detailed description. The limitations in the claims are to be interpreted broadly based on the language employed in the claims and not limited to examples described in the foregoing detailed description or during the prosecution of the application, which examples are to be construed as non-exclusive. For example, in the present disclosure, the term “preferably” is non-exclusive where it is intended to mean “preferably, but not limited to.” Any steps recited in any method or process claims may be executed in any order and are not limited to the order presented in the claims. Means-plus-function or step-plus-function limitations will only be employed where for a specific claim limitation all of the following conditions are present in that limitation: a) “means for” or “step for” is expressly recited; and b) a corresponding function is expressly recited. The structure, material or acts that support the means-plus function limitation are expressly recited in the description herein. Accordingly, the scope of the invention should be determined solely by the appended claims and their legal equivalents, rather than by the descriptions and examples given above.

What is claimed and desired to be secured by Letters Patent is:

1. A touch-based input device providing a reconfigurable user interface, said touch-based input device comprising:
an input receiving element having a touch sensitive contacting surface as part of a first configured user interface adapted to receive an applied force;
a sensor operable to detect and to facilitate determination of at least a location of said applied force; and
at least one static component removably disposed at a first location about said input receiving element, and adapted to at least partially define said first configured user interface,
said static component being movable to a second location about said input receiving element to reconfigure said user interface and to at least partially define a second configured user interface.

2. The touch-based input device of claim 1, said static component providing a touch sensitive contacting surface upon disposal about said input receiving element.

3. The touch-based input device of claim 1, wherein said static component becomes touch sensitive upon being disposed about said input receiving element without external interaction with the sensing element.

4. The touch-based input device of claim 1, wherein said touch-based input device arranged in said first configured user interface performs substantially the same functionality as said touch-based input device arranged in said second configured user interface.

5. The touch-based input device of claim 1, wherein said touch-based input device arranged in said first configured user interface performs a substantially different functionality as said touch-based input device arranged in said second configured user interface.

6. The touch-based input device of claim 1, wherein said input receiving element and said sensing element are integrally formed with one another.

7. The touch-based input device of claim 1, wherein said input receiving element and said sensing element are independent of one another and are located in different planes with respect to one another.

8. The touch-based input device of claim 1, wherein said static component comprises a material different from said contacting surface.

9. The touch-based input device of claim 1, wherein said static component is adapted to transfer said applied force received on said contacting surface to said sensing element.

10. A touch-based input device in accordance with claim 1, wherein said touch-based input device operates to sense said applied force and to determine a location of said applied force on said static component, which registers about substantially the same coordinates as if said force were being applied directly to said input receiving element.

11. A touch-based input device in accordance with claim 1, wherein said static component comprises multiple differentiated touch zones on a single input surface.

12. A touch-based input device in accordance with claim 1, wherein said static component is interchangeable with a second static component, and wherein said second static component may be disposed about either of said first and second locations about the input receiving element.

13. A touch-based input device in accordance with claim 1, wherein said static component is supported about said input receiving element using quick-release attachment means selected from the group consisting of a magnet, a hook and loop fastener, a snap or snap-like fastener, a zipper, an adhesive, and any combination of these.

14. A touch-based input device in accordance with claim 1, wherein said static component is supported about said input receiving element using attachment means selected from the group consisting of a screw assembly, a bolt assembly, and any combination of these.

15. A touch-based input device in accordance with claim 1, wherein said static component receives said applied force about an input surface.

16. A touch-based input device in accordance with claim 15, wherein said input surface comprises a non-rigid material.

17. A touch-based input device in accordance with claim 16, wherein the non-rigid material is selected from the group consisting of leather, cloth, neoprene, fur, silicone, polycarbonate, and any combination of these.

18. A touch-based input device in accordance with claim 15, wherein said input surface comprises a rigid material.

19. A touch-based input device in accordance with claim 18, wherein the rigid material is selected from the group consisting of stone, metal, plastic, laminate, glass, composite, tactile feedback, and any combination of these.

20. A touch-based input device in accordance with claim 1, wherein said static component comprises multiple layers, each comprising an input surface, and each able to transfer an applied force to any lower layers and said sensing element.

21. A touch-based input device in accordance with claim 1, wherein an increase in the static mass acting upon the sensitive surface resulting from the static component is accounted for during calibration of said touch-based input device.

22. A touch-based input device in accordance with claim 21, wherein said static mass fluctuates with the addition or removal of said static component, said touch-based input device configured to account for said fluctuation of said static mass to enhance the accuracy of said touch-based input device with respect to the location of said applied force.

23. A touch-based input device in accordance with claim 1, wherein said static component comprises a first static component and a second static component supported about the first static component.

24. A touch-based input device in accordance with claim 1, wherein a component configuration is electromechanically detected by the touch-sensitive input device.

25. A touch-based input device in accordance with claim 1, wherein said first or second user interface is customizable by a user using one or more of said static components.

26. A touch-based input device in accordance with claim 1, wherein said input receiving element comprises first input receiving element and a second input receiving element disposed above the first input receiving element and coupled to the first input receiving element such that forces applied to the second input receiving element are transferred to the first input receiving element.

27. A touch-based input device in accordance with claim 1, wherein said input receiving element is capable of detecting the magnitude of a force applied to said static component.

28. A touch-based input device in accordance with claim 1, wherein the input receiving element further comprises a three-dimensional surface disposed on the input receiving element.

29. A touch-based input device in accordance with claim 1, wherein the input receiving element further comprises a three-dimensional surface integrally formed with the input receiving element.

30. A touch-based input device comprising:
an input receiving element having a touch sensitive contacting surface adapted to receive an applied force;
a sensor operable to detect and to facilitate determination of at least a location of said applied force; and
at least one static component disposed about said input receiving element;
said touch-based input device being adapted to detect a force applied to said static component in any direction.

31. The touch-based input device of claim 30, wherein said input receiving element and said sensing element are integrally formed with one another.

32. The touch-based input device of claim 30, wherein said input receiving element and said sensing element are independent of one another and located in different planes, with respect to one another.

33. A touch-based input device in accordance with claim 30, wherein said static component is at least partially disposed about a front surface of said touch-based input device and is mounted to said touch-based input device such that a force applied to the static component results in a force applied to a rear surface of said touch-based input device.

34. A force-based input device comprising:
a first structural element supported in a fixed position;
a second structural element operable with said first structural element, and dynamically supported to be movable with respect to said first structural element to define a sensing element configured to displace under an applied force;
a plurality of isolated beam segments joining said first and second structural elements, said isolated beam segments being operable to transfer forces between the first and second structural elements resulting from displacement of said sensing element;
at least one sensor operable to measure strain within each of said isolated beam segments resulting from said transfer of forces and said displacement of said sensing element, each of said sensors being configured to output a signal, corresponding to said applied force and said measured strain, to be used to determine a location of said applied force on said sensing element; and
a component supported about said sensing element that receives and transfers said applied force to said sensing element to facilitate or cause said displacement of said sensing element, thus registering a force, said force-based input device operating to sense said component and to determine a location of said applied force on said component, which registers substantially the same coordinates as if said force were being applied directly to said sensing element.

35. A method for reconfiguring a user interface within a touch-based input device, said method comprising:
disposing a static component at a first location about an input receiving element to at least partially define a first user interface;
receiving an applied force about at least one of said static component and said input receiving element;
sensing said applied force to determine at least a location of said applied force; and
relocating said static component to a second location about said input receiving element to at least partially define a second configured user interface.

36. The method of claim 35, further comprising adding a second static component about said input receiving element
